(19) United States
(12) Patent Application Publication
(10) Pub. No.: US 2019/0239675 A1
(43) Pub. Date: Aug. 8, 2019

(54) DRAPE CLOSURE

(71) Applicant: 3M INNOVATIVE PROPERTIES COMPANY, St. Paul, MN (US)

(72) Inventor: Paul J. Northey, Somerset, WI (US)

(21) Appl. No.: 16/333,311

(22) PCT Filed: Sep. 11, 2017
(86) PCT No.: PCT/US2017/050879

§ 371 Date: Mar. 14, 2019

Related U.S. Application Data
(60) Provisional application No. 62/394,344, filed on Sep. 14, 2016.

(51) Int. Cl. A47H 23/01; H01F 7/02

(52) U.S. Cl. CPC A47H 23/01; H01F 7/02

(57) ABSTRACT

The present disclosure includes a retrofit magnet strip kit and method for mating the vertical edges of two adjacent drapes (110, 120), the kit comprising a first magnet strip (200) and a second magnet strip (200). Each magnet strip (200) comprises a non-magnetic substrate (201) with two major surfaces, wherein the thickness of the substrate (201) is less than 1 cm, the width of the substrate (201) is between 1 cm and 8 cm and the length of the substrate (201) is greater than 20 centimeters (cm), and at least two magnets (210, 220) attached to a first major surface of the substrate (201). The two magnets (210, 220) are spaced apart from each other, and a first edge of the first magnet is at least 5 cm from the nearest edge of the second magnet. The first magnet (210) comprises magnetic material with maximum energy 3 product least 200 kj/m. When the first and second magnet strips are inserted into the vertical hems of two adjacent drapes (110, 120), the magnet strips (210, 220) are attracted to each other and cause the vertical edges of the two adjacent drapes (110, 120) to mate with each other such that the first magnet on the first magnet strip and the first magnet on the second strip mate with each other, and the second magnet on the first magnet strip and the second magnet on the second magnet strip mate with each other.

### FIELD OF INVENTION

The present invention relates to a kit and method for retrofitting vertically hanging drapes such that the adjacent edges of the drapes can be mated and secured to each other. The present invention can also be applied to newly manufactured drapes.

### BACKGROUND

Conventional drapes on windows and in other applications often come in multiple panels, so that the panels can be separated to allow light to pass between the panels or to expose the view behind the panels. However, when adjacent vertically hanging drape panels are slid together in an effort to totally cover the background behind the panels or block light from coming through a window behind the panel, it is very difficult to get the panels to achieve a tight closure while they are simply hanging adjacent to each other. The problems associated with the difficulty of closing drapes can be exacerbated in situations where a particularly bright light source exists outside the window, such as a flood light in a parking lot outside a hotel room window. This can also be problematic for individuals who work at night and need to sleep during daylight hours.

Others have tried to solve the problem of light being transmitted by using heavier or stiffer drapery, using retrofit blackout lining, and hook and loop mechanical fasteners as discussed in WO 94/13182 to Leaderman et al. However, even these solutions provide opportunity for improvement.

### SUMMARY

In one instance, the present disclosure includes a retrofit magnet strip kit for mating the vertical edges of two adjacent drapes, the kit comprising a first magnet strip and a second magnet strip. Each magnet strip comprises a non-magnetic substrate with two major surfaces, wherein the thickness of the substrate is less than 1 cm, the width of the substrate is between 1 cm and 8 cm and the length of the substrate is greater than 20 centimeters (cm), and at least two magnets attached to a first major surface of the substrate. The two magnets are spaced apart from each other, and a first edge of the first magnet is at least 5 cm from the nearest edge of the second magnet. The first magnet comprises magnetic material with maximum energy product of at least 200 kJ/m³. When the first and second magnet strips are inserted into the vertical hems of two adjacent drapes, the magnet strips are attracted to each other and cause the vertical edges of the two adjacent drapes to mate with each other such that the first magnet on the first magnet strip and the first magnet on the second strip mate with each other, and the second magnet on the first magnet strip and the second magnet on the second magnet strip mate with each other.

In another instance, the present disclosure includes a method of retrofitting two adjacent drapes to allow mating of the vertical edges of the adjacent drapes. The method comprises providing a first magnet strip and a second magnet strip. Each magnet strip comprises a non-magnetic substrate with two major surfaces. The thickness of the substrate is less than 1 cm, the width of the substrate is between 1 cm and 8 cm and the length of the substrate is greater than 20 cm. At least two magnets are attached to a first major surface of the substrate, where the two magnets are spaced apart from each other, and wherein a first edge of the first magnet is at least 5 cm from the nearest edge of the second magnet. The first magnet comprises magnetic material with maximum energy product of at least 200 kJ/m³. The method further comprises inserting the first magnet strip into a vertical hem of the first drape; and inserting the second magnet strip into a vertical hem of the second drape. The method further comprise drawing the vertical hem of the first drape toward the vertical hem of the second drape until the first and second magnet strips are physically attracted to each other and cause the vertical edges of the two adjacent drapes to mate with each other such that the first magnet on the first magnet strip and the first magnet on the second strip mate with each other, and the second magnet on the first magnet strip and the second magnet on the second magnet strip mate with each other.

In another instance, the present disclosure includes a drape adapted for easy closure. The drape comprises a substantially rectangular drape material, wherein the drape material includes a fixture mechanism at a first edge of the drape material to affix the drape to a hanging mechanism. The drape further comprises a vertical hem on a second edge of the drape material, wherein the second edge is adjacent to the first edge. A magnet strip is enclosed in the folded portion of material created by the vertical hem. The magnet strip comprises a non-magnetic substrate with two major surfaces, wherein the thickness of the substrate is less than 1 cm, the width of the substrate is between 1 cm and 8 cm and the length of the substrate is greater than 20 cm. At least two magnets are attached to a first major surface of the substrate, where the two magnets are spaced apart from each other, and wherein a first edge of the first magnet is at least 5 cm from the nearest edge of the second magnet. The first magnet comprises magnetic material with maximum energy product of at least 200 kJ/m³′

In some instances, the substrate has a stiffness greater than 0.005 Newtons per meter (N/m) and less than 1.0 (N/m).

In some instances, the substrate has a modulus of elasticity greater than 0.05 GPa and less than 5 GPa.

In some instances, the thickness of the first substrate is less than 3 millimeters.

In some instances, the width of the first substrate is less than 5 centimeters.

In some instances, the length of the first substrate is equal to or greater than 1 meter.

In some instances, the first edge of the first magnet on the first magnet strip is at least 10 cm from the nearest edge of the second magnet on the first magnet strip.

In some instances, the first magnet and the second magnet are embedded into the first substrate.

In some instances, when the vertical edges of the first drape and the second drape are mated, the first drape and second drape overlap by at least 1 cm.

Various embodiments of the present disclosure provide a variety of advantages over existing drape closure mechanisms or light blocking mechanisms. For example, the present disclosure provides magnetic strips that are of sufficient strength that adjacent hanging vertical drape retrofit with such magnet strips can be closed and opened using a single hand and with no additional actions typically required for buttons, snaps, clips and the like. The present disclosure does not alter the visual appearance of the exterior of the drapes. The present disclosure allows retrofitting of existing drapes with minimal effort, and without requiring the drapes to be removed from their hanging mechanism. The present disclosure allows drapes of varying heights to be retrofit without wasting lengths of magnet strips. The present disclosure can ensure adjacent edges of vertically hanging drapes are aligned with each other when they are mated together. Other advantages will be apparent to one of ordinary skill in the art upon reading the present disclosure. The present invention can also be easily manufactured, particularly when manufactured in a roll good format as shown in FIG. 5.

### BRIEF DESCRIPTION OF THE DRAWINGS

The invention may be more completely understood in consideration of the following detailed description of various embodiments of the invention in connection with the accompanying drawings, in which:

FIG. 1 shows two adjacent vertically hanging drapes.

FIG. 2 shows an exemplary magnet strip.

FIG. 3 shows a cross section of an exemplary magnet strip.

FIG. 4 shows exemplary magnet strips inserted into vertical hems of two adjacent drapes.

FIG. 5 shows a roll from which magnet strips can be cut.

FIG. 6 shows example magnet strips.

It is to be understood that the embodiments may be utilized and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

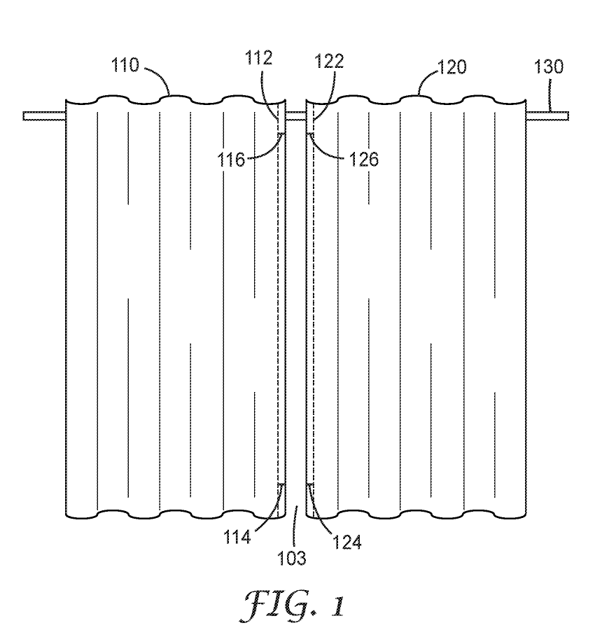

FIG. 1 shows vertically hanging drape 110 adjacent to drape 120 both mounted on rod 130. In some instances, drapes 110 and 120 may be hanging in front of a window, an opening, a wall, a door, or an item to be covered or concealed. In many of these situations, gap 103 between drape 110 and drape 120 can be problematic. For example, gap 103 may allow light from a flood lamp outside of a window behind drape 110 and 120 to shine into a hotel room, making it difficult for the hotel room occupant to sleep well. Gap 103 may allow wind to pass more easily than desired between drape 110 and drape 120. Gap 103 may cause visual exposure of an item or area intended to be covered or blocked by drape 110 and drape 120.

The present disclosure provides a solution to these problems. The present disclosure includes a retrofit magnet strip kit for mating the vertical edges of drape 110 and drape 120. Many drapes, when sewn, include vertical hems along each of their vertical edges. Hem 112 and hem 122 provide a finished appearance to the vertical edges of drapes 110 and 120 respectively. The retrofit magnet strips disclosed herein can be concealed in the opening created by the folded portion of fabric sewn closed by vertical hems 112 and 122. Magnet strips as described herein can be added to existing drapes to retrofit them, or can be manufactured into newly made drapes.

As discussed in further detail herein, a retrofit magnet strip kit includes a first magnet strip and a second magnet strip. Each magnet strip includes a non-magnetic substrate with two major surfaces, with magnets disposed at discrete intervals along the substrate. A magnet strip can be manufactured or cut to the desired height for the drape at issue. For example, to retrofit drapes 110 and 120, a magnet strip may be cut to a length slightly shorter than the total length of the drape.

When an appropriate-length magnet strip is cut or created, the magnet strip can be used to retrofit drapes 110 and 120. To retrofit drapes 110 and 120, a slit can be cut in the fabric of each of drapes 110 and 120 to create an opening in the folds of fabric sewn closed by vertical hems 112 and 122. The slit may be placed near either the top or bottom of drapes 110 and 120, and the magnet strip can be guided through the opening and into the folded portion of cloth created by vertical hem 112 and 122. Slits 116 and 126 are placed near the top of vertical hems 112 and 122, and slits 114 and 124 are placed near the bottom of vertical hems 112 and 122. The two magnet strips are inserted such that the magnets of the first magnet strip are attracted to the magnets of the second magnet strip.

Once the magnet strips are inserted into the vertical hems of adjacent drapes 110 and 120, the drapes can be drawn toward each other. In some instances the drapes are drawn toward each other using a pulley system attached to rod 130. In some instances, drapes are drawn toward each other by a user pulling the drape 110 or 120 in the desired direction by applying a force to a vertical edge of drape 110 or drape 120. When drapes 110 and 120 are drawn toward each other, the magnet strips in vertical hems 112 and 122 are attracted to each other and cause the vertical edges of the two adjacent drapes to mate with each other. The magnet strips can mate in a manner such that the magnet disposed on the magnet strip in drape 110 nearest the bottom of drape 110 mates with the magnet in the corresponding position on the magnet strip in drape 120. This helps to ensure that the drapes are vertically aligned with each other when they are mated.

The drapes can be mated in a variety of ways. In some configurations, the drapes may be mated such that the adjacent edges of drapes 110 and 120 touch each other. In some configurations, the drapes may be mated such that the back side of vertical hem 112 of drape 110 mates against the back side of vertical hem 122 of drape 120. In some configurations, drapes 110 and 120 may be mated such that the back side of vertical hem 122 overlaps with the front of vertical hem 112. The amount of overlap may depend on the manner in which the drapes are hung, the weight of the material of the drapes, the strength, size and spacing of the magnets used for the retrofit magnet strips. In some instances, when drapes are mated after being retrofit with magnet strips consistent with the present disclosure, the vertical hems of the drape may overlap by a minimum of 0.5 cm, 1 cm, 1.5 cm, 2 cm, 2.5 cm, 3 cm, or more.

Drapes consistent with the present disclosure can be made of a variety of materials. Examples of such materials include, but are not limited to, textile such as canvas, linen, cotton fabrics and other textiles; vinyl and other types of plastics; a screen, mesh or netting material, and manmade fibers, such as nylon; and a nonwoven, pressed or bonded material.

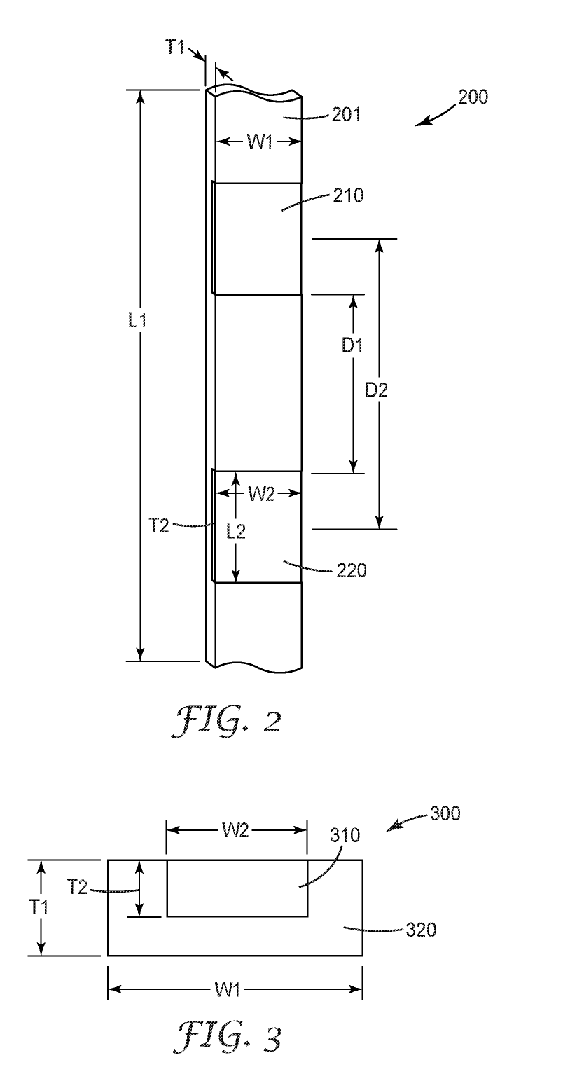

FIG. 2 shows an exemplary magnet strip 200. Only a portion of a magnet strip 200 is shown, magnet strip may be any desired length based on the height of the drapes that magnet strip is being inserted into. Magnet strip 200 comprises a non-magnet substrate 201 with two major surfaces. In FIG. 2, only a top major surface is visible, a corresponding back major surface is opposite the top surface shown in FIG. 2. While substrate 201 may be a variety of shapes and sizes, generally, the thickness T1 of substrate 201 is less than 1 cm. In some instances, T1 may be less than any of 0.75 cm, 0.5 cm, 0.4 cm, 0.3 cm, 0.2 cm or 0.1 cm. If T1 is too great, it may increase the difficulty of inserting magnet strip 200 into a vertical hem of a drape. Further, if T1 is too thick, magnet strip 200 may cause the drape to hang in an uneven or awkward fashion due to the weight or bulk of magnet strip 200. The width W1 of magnet strip 200 is generally greater than T1, and may be between 1 cm and 8 cm wide. For example, width W1 may be greater than 1 cm and less than any of 2 cm, 2.5 cm, 3 cm, 4 cm, 5 cm, 6 cm, 7 cm, or 8 cm. Width W1 may also be limited by the width of the fabric of the drape folded to create a vertical hem. Generally, width W1 is less than the width of the fabric spanning from the vertical edge of a hanging drape to the stitching creating the hem, or folded portion of fabric of the drape to allow magnet strip 200 to be inserted into the folded portion of fabric.

Substrate 201 may have any desired length L1 based on the height of drapes into which magnet strip 200 is being inserted. For example, length L1 may be greater than any of 20 cm, 30 cm, 40 cm, 50 cm, 60 cm, 70 cm, 80 cm, 90 cm, 1 m, 1.5 m, 2 m or greater. Length L1 may be determined during manufacture such that magnet strips are available in a variety of standard lengths. Alternately, length L1 may be determined by a user who is using a retrofit magnet strip to retrofit a drape. In this instance, magnet strip 200 may be sold as a roll good or in large portions, and a user may cut magnet strip 200 to the desired length while ensuring that magnets on the first magnet strip will align with magnets on the second magnet strip.

Substrate 201 may be made of a variety of materials. Some examples of materials that substrate 201 may be made of include poly methyl methacrylate (PMMA), polycarbonate, polystyrene, acrylonitrile butadiene styrene (ABS), polyethylene, polypropylene, or nylon, for example. Other materials will be apparent to one of ordinary skill in the art upon reading the present disclosure. In many instances, substrate 201 is made of a non-magnetic material, and has sufficient rigidity to allow it to be inserted without the aid of any tools into the fabric fold in the vertical seam of a drape. In some instances, the substrate has a stiffness in the range of 0.001 to 1.0 Newtons per meter (N/m). In a preferred embodiment, substrate 201 has a stiffness in the range of 0.001 to 0.1 N/m.

Substrate 201 can also be characterized by its modulus of elasticity. In some instances, substrate 201 has a modulus of elasticity in the range of 0.05 to 5 gigapascals (GPa). In a preferred embodiment, substrate 201 has a modulus of elasticity in the range of 2-5 GPa.

Magnets 210 and 220 are attached or mechanically affixed to substrate 201. In some instances, magnets 210 and 220 are adhered to substrate 201 with a pressure sensitive or other type of adhesive. In other instances, magnets 210 and 220 may attached to substrate 201 using a clip, screw, or other mechanical fixture. In some configurations, substrate 201 is comprised of two separate substrates, and magnets 210 and 220 are enclosed between the two substrates. In some instances, magnets 210 and 220 are embedded in substrate 201.

Magnet 210 and 220 may be a variety of types of magnets. Important factors in selecting an effective magnet include the weight of the fabric of the drape to be retrofit, the size of the magnets, the spacing between the magnets and the maximum energy product of the magnetic material the magnet is comprised of A variety of types of magnetic materials may be used. In one instance, magnets made from neodymium may be used. In one instance, magnets 210 and 220 are made of a magnetic material with a maximum energy product least 200 kJ/m³. Samarium-cobalt may be another magnetic material for use consistent with the present disclosure.

Magnets 210 and 220 may have varying length L2, width W2 and thickness T2. In one configuration, length L2 is greater than any one of 1 cm, 1.5 cm, 2 cm, 2.5 cm, 3 cm, 4 cm or 5 cm, or in the range between any of the two preceding lengths. In one instance, thickness T2 is in the range of 0.125 cm to 0.65 cm. Width W2 may be any width up to width W1 of the substrate 201.

Magnets 210 and 220 are spaced apart from each other on substrate 201. The spacing between magnets 210 and 220 can be measured as a distance between each magnet's center point (distance D2) or between the two nearest edges of the magnets (distance D1). Distance D1 can be any desired distance. Distance D1 may be greater than 1 cm, 2 cm, 3 cm, 4 cm, 5 cm, 10 cm, 15 cm, or 20 cm, for example. Distance D2 may depend on the length of magnets 210 and 220, but may be greater than 3 cm, 4 cm, 5 cm, 10 cm, 15 cm, or 20 cm. Spacing magnets 210 and 220 apart from each other allows the magnets on respective magnet strips to align relative to each other when the vertical edges of drapes in which the magnet strips 200 are inserted into drapes. While only two magnets are shown in FIG. 2, more than two magnets may be disposed along the strip at recurring or varying intervals of distance, so long as the intervals for two strips used to retrofit a pair of drapes mirror each other. Additionally, there may be some instances where a series of three, four, or more vertically hanging drapes are all mated together using multiple pairs of magnet strips 201. Generally, the two magnet strips are inserted such that the opposing or corresponding magnets of the first magnet strip are attracted to the magnets of the second magnet strip and the magnetic poles are aligned such that the magnetic force will attract the strips to each other.

FIG. 3 shows a cross section of an exemplary magnet strip 300. In FIG. 3, magnet 310 is embedded into substrate 320 to create a flat surface for both major surfaces of magnet strip 300. Width W2 of the magnet is less than width W1 of substrate 320 in FIG. 3. In other embodiments, width W2 may be the same as W1 or greater than width W1. Similarly, thickness T2 of the magnet is less than thickness T1 of the substrate 320.

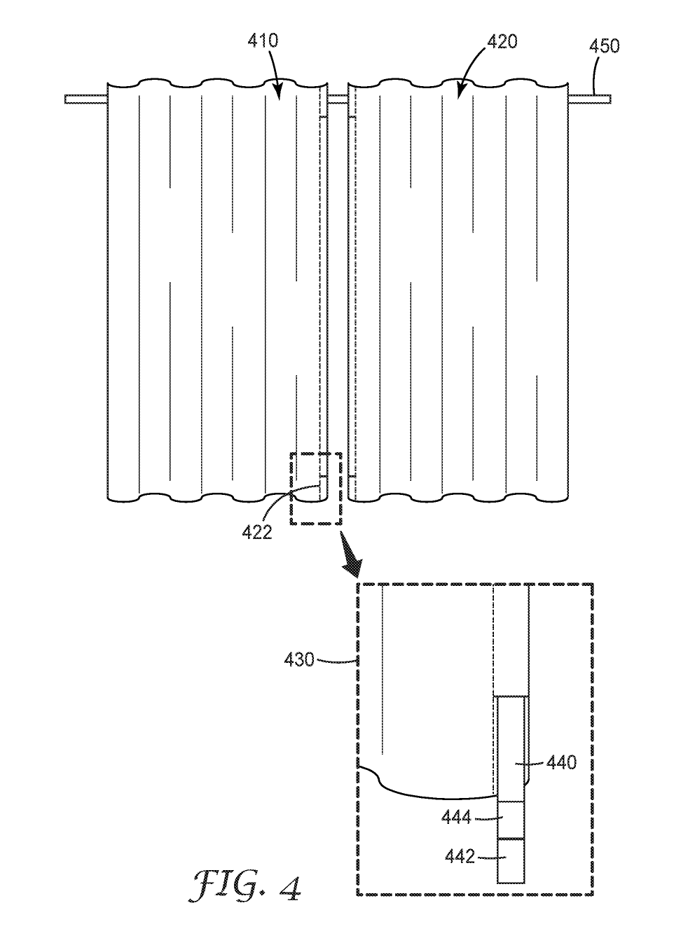

FIG. 4 shows exemplary magnet strips 440 inserted into vertical hems 412 and 422 of two adjacent drapes 410 and 420. Drapes 410 and 420 are hanging from rod 450. As shown in inset 430, vertical hems 412 and 422 are slit open near the bottom of each vertical hem 412 and 422 to create an opening into which magnet strip 440 can be inserted. Magnet strip is inserted upward into the fabric fold created by the vertical hem 412 and 422, and once entirely inserted into the fabric hold is allowed to rest along the bottom of fabric hold. The distance between the bottom edge of the substrate 442 and the lowest magnet 444 is the same to allow the drape edges to mate with each other in an aligned fashion. The two magnet strips are inserted such that the magnets of the first magnet strip are attracted to the magnets of the second magnet strip, and the magnetic poles are aligned such that the magnetic force will attract the strips to each other.

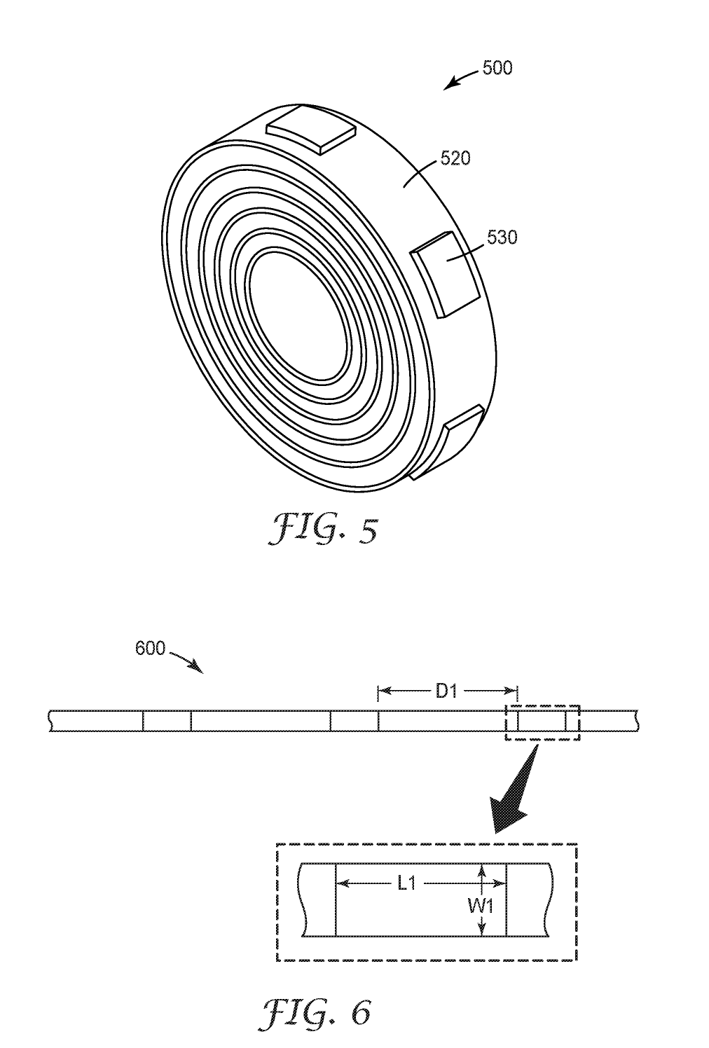

FIG. 5 shows a roll 500 from which magnet strips can be cut. In one instance, magnet strips may be manufactured in a continuous fashion and wound around a core 510, such that an individual could cut sections of the magnet strip 520 wound around the core to the desired length for each retrofit project. Each magnet strip pair should be cut so that the distance between the bottom end of the substrate and the lowest magnet is the same, to allow alignment of the drapes when they are mated.

### EXAMPLE

Adhesive-backed neodymium magnets with a width W1 measuring 12.7 mm and a length L1 measuring 25.4 mm, available for purchase from US Magnetix of Golden Valley, Minn., sold under part number NTA.5x1x.060, were applied to a 1 mm×12.7 mm×1 m acrylic substrate at 25 cm intervals D1 measured from the center of a first magnet to the center of the adjacent magnet to form magnetic strips 600 as shown in FIG. 6. One magnetic strip was inserted into each folded vertical hem of two opposing closing curtains on rails as shown in FIG. 4. The magnetic strips were inserted such that the magnets were at the same relative height in each curtain, and such that they attracted each other when brought into the closing position. The curtain fabric was 160 g/square m. Curtain dimensions were 0.5 m wide by lm long, and the gap between the two curtain rails was 2 cm. When moved from open to closed position, the curtains “snapped” together by magnetic force.

What is claimed is:

1. A retrofit magnet strip kit for mating the vertical edges of two adjacent drapes, the kit comprising:
a first magnet strip and a second magnet strip, wherein each magnet strip comprises:
a non-magnetic substrate with two major surfaces, wherein the thickness of the substrate is less than 1 cm, the width of the substrate is between 1 cm and 8 cm and the length of the substrate is greater than 20 cm;
at least two magnets attached to a first major surface of the substrate, where the two magnets are spaced apart from each other, and wherein a first edge of the first magnet is at least 5 cm from the nearest edge of the second magnet;
wherein the first magnet comprises magnetic material with maximum energy product of at least 200 kJ/m³; and
wherein when the first and second magnet strips are inserted into the vertical hems of two adjacent drapes, the magnet strips are attracted to each other and cause the vertical edges of the two adjacent drapes to mate with each other such that the first magnet on the first magnet strip and the first magnet on the second strip mate with each other, and the second magnet on the first magnet strip and the second magnet on the second magnet strip mate with each other.

2. The kit of claim 1, wherein the substrate has a stiffness greater than 0.001 Newtons per meter (N/m) and less than 1.0 (N/m).

3. The kit of claim 1, wherein the substrate has a modulus of elasticity greater than 0.05 GPa and less than 5 GPa.

4. The kit of claim 1, wherein the thickness of the first substrate is less than 3 millimeters.

5. The kit of claim 1, wherein the width of the first substrate is less than 5 centimeters.

6. The kit of claim 1, wherein the length of the first substrate is equal to or greater than 1 meter.

7. The kit of claim 1, wherein the first edge of the first magnet on the first magnet strip is at least 10 cm from the nearest edge of the second magnet on the first magnet strip.

8. The kit of claim 1, wherein the first magnet and the second magnet are embedded into the first substrate.

9. A method of retrofitting two adjacent drapes to allow mating of the vertical edges of the adjacent drapes, the method comprising:
providing a first magnet strip and a second magnet strip, wherein each magnet strip comprises:
a non-magnetic substrate with two major surfaces, wherein the thickness of the substrate is less than 1 cm, the width of the substrate is between 1 cm and 8 cm and the length of the substrate is greater than 20 cm;
at least two magnets attached to a first major surface of the substrate, where the two magnets are spaced apart from each other, and wherein a first edge of the first magnet is at least 5 cm from the nearest edge of the second magnet;
wherein the first magnet comprises magnetic material with maximum energy product of at least 200 kJ/m³; and
inserting the first magnet strip into a vertical hem of the first drape;
inserting the second magnet strip into a vertical hem of the second drape;
drawing the vertical hem of the first drape toward the vertical hem of the second drape until the first and second magnet strips are physically attracted to each other and cause the vertical edges of the two adjacent drapes to mate with each other such that the first magnet on the first magnet strip and the first magnet on the second strip mate with each other, and the second magnet on the first magnet strip and the second magnet on the second magnet strip mate with each other.

10. The method of claim 9, wherein the substrate has a stiffness greater than 0.001 Newtons per meter (N/m) and less than 1.0 (N/m).

11. The method of claim 9, wherein the substrate has a modulus of elasticity greater than 0.05 GPa and less than 5 GPa.

12. The method of claim 9, wherein the thickness of the first substrate is less than 3 millimeters.

13. The method of claim 9, wherein the width of the first substrate is less than 5 centimeters.

14. The method of claim 9, wherein the length of the first substrate is equal to or greater than 1 meter.

15. The method of claim 9, wherein the first edge of the first magnet on the first magnet strip is at least 10 cm from the nearest edge of the second magnet on the first magnet strip.

16. The method of claim 9, wherein the first magnet and the second magnet are embedded into the first substrate.

17. The method of claim 9, wherein when the vertical edges of the first drape and the second drape are mated, the first drape and second drape overlap by at least 1 cm.

18. A drape adapted for easy closure, the drape comprising:
a substantially rectangular drape material, wherein the drape material includes a fixture mechanism at a first edge of the drape material to affix the drape to a hanging mechanism;
a vertical hem on a second edge of the drape material, wherein the second edge is adjacent to the first edge;
a magnet strip enclosed in the folded portion of material created by the vertical hem, wherein the magnet strip comprises:
a non-magnetic substrate with two major surfaces, wherein the thickness of the substrate is less than 1 cm, the width of the substrate is between 1 cm and 8 cm and the length of the substrate is greater than 20 cm;
at least two magnets attached to a first major surface of the substrate, where the two magnets are spaced apart from each other, and wherein a first edge of the first magnet is at least 5 cm from the nearest edge of the second magnet; and
wherein the first magnet comprises magnetic material with maximum energy product least of at 200 kJ/m³.
